(19) United States
(12) Patent Application Publication
(10) Pub. No.: US 2017/0312577 A1
(43) Pub. Date: Nov. 2, 2017

(54) System and Method for Sport Performance Monitoring, Analysis, and Coaching

(71) Applicants: Jon Sisson, Dallas, TX (US); Mike Clark, Milton, GA (US)

(72) Inventors: Jon Sisson, Dallas, TX (US); Mike Clark, Milton, GA (US)

(21) Appl. No.: 15/494,717

(22) Filed: Apr. 24, 2017

Related U.S. Application Data
(60) Provisional application No. 62/328,586, filed on Apr. 27, 2016.
(60) Provisional application No. 62/375,895, filed on Aug. 16, 2016.

(51) Int. Cl. A63B 24/00; G09B 1/00; G09B 19/00; G09B 5/02

(52) U.S. Cl. CPC A63B 24/0062; G09B 19/0038; G09B 5/02; A63B 24/0075; G09B 1/00; A63B 2220/40

(57) ABSTRACT

A smart kinesiology system includes a mobile app executing on a mobile device, and a smart kinesiology device is configured to be worn by an athlete and includes a microprocessor, a transceiver coupled to the microprocessor and configured for wireless communication with the mobile app, a user interface device in communication with the microprocessor for receiving user input, a motion sensor module coupled to the microprocessor and configured for sensing and measuring motions of the athlete performing a plurality of drills, generating motion data, and providing the motion data to the microprocessor, and a vibrator coupled to the microprocessor configured for generating a vibration in response to receiving an instruction from the microprocessor. The microprocessor is configured to transmit the motion data to the mobile app, and provide vibratory feedback information to the athlete based on the athlete's progress through the plurality of drills.

### RELATED APPLICATION

The present application claims the benefit of U.S. Provisional Patent Application Nos. 62/328,586 and 62/375,895 filed on Apr. 27, 2016 and Aug. 16, 2016, respectively.

### FIELD

The present disclosure relates to the field of human motion monitoring and analysis, and in particular a system and method for sport performance monitoring, analysis, and coaching.

### BACKGROUND

Athletes are often exposed to team sports at a very young age by parents and coaches for the benefits of team work, competition, and health benefits. Young athletes are encouraged to participate in sports that require repetitive movements of their arms and legs to throw, pass, and kick balls, and swinging bats, hockey sticks, etc.

The youth team sports landscape has changed dramatically in the past ten years. Athletes as young as eight years old are now declaring a single sport specialization and are experiencing increasingly higher performance expectations once reserved for high school age athletes. Athletes ages 8 to 19 who hope to progress through more advanced levels of the sport are finding that the coaching and training methods available to them don't adequately prepare for elite level competition and even higher athletic performance expectations. Many young athletes who train without proper supervision often experience avoidable injuries or are so discouraged that they drop out of organized sports altogether.

The reasons for this are many fold. There is an over reliance on scrimmaging and not establishing position fundamentals, which is the first requirement for athletes to build an understanding of the game itself and to materially contribute to overall team success. At the youth level, mere participation has become the goal. Recent societal opinion that winning and losing does not matter is driving coaching behavior to focus on the social experience of organized sports, not teaching kids how to become athletes. On the other end of the spectrum, elite and advanced sports leagues prioritize winning over developing technical position skills, game acumen, and proper physical conditioning to avoid unnecessary sports-related injury. In either case, the fundamentals of how to play the game are being systematically de-emphasized from youth-level sports.

Another reason is that an athlete's training and physical conditioning during the bulk of the calendar year, i.e., the off season, is largely invisible to the coaching staff. This long time period away from individual coaching oversight results in significant lost developmental opportunities. Physical overuse injuries have become more prevalent and injury prevention methods are inadequate. With single sport specialization pervading the youth sports year-round competition, and not enough time off for rest, injuries have become common. This increasingly more intense physical activity during formative-high growth years is taxing on young muscles, ligaments, tendons, and joints.

Further, general physical education programs in schools, the main source of physical conditioning information for youth teen athletes between the ages of 8 and 19, teach the same general workout principles regardless of the student's sport of choice. For example, physical education coaches train a football player the same as a baseball player. Yet the physical demands on a football player couldn't be more different from those of a baseball, soccer, or basketball player. Thus, the lack of specific position sport physical training leaves these athletes at risk to injury because their bodies are not prepared for the unique physical demands of the sport and the specific position they play.

### BRIEF DESCRIPTION OF THE DRAWINGS

FIG. 1 is a simplified block diagram of an exemplary embodiment of the sport performance monitoring, analysis, and coaching system and method according to the teachings of the present disclosure;

FIG. 2 is an illustration of a wearable smart kinesiology device according to the teachings of the present disclosure;

FIGS. 3-5 are exemplary data displays associated with drilling and movement measurements according to the teachings of the present disclosure;

FIGS. 6 and 7 are flowcharts of exemplary embodiments of process flows associated with profile creation and initiation processes according to the teachings of the present disclosure.

### DETAILED DESCRIPTION

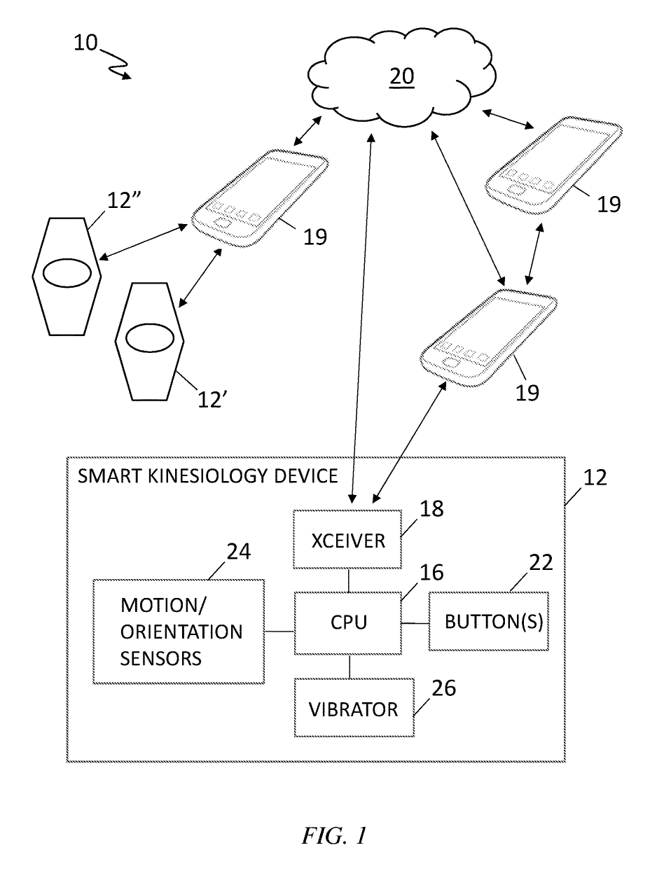

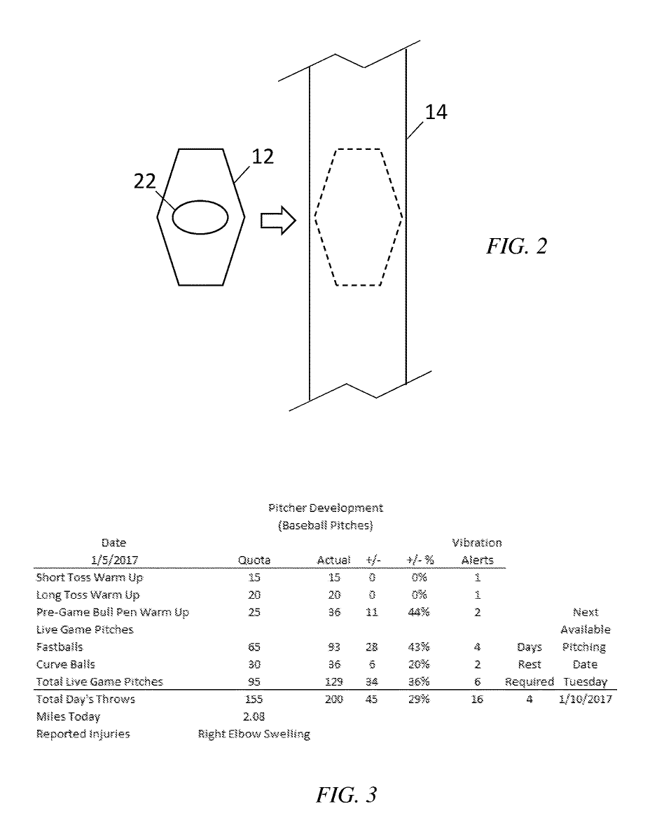

FIG. 1 is a simplified block diagram of an exemplary embodiment of the sport performance monitoring, analysis, and coaching system and method 10 according to the teachings of the present disclosure. The system 10 includes one or more smart kinesiology devices 12-12″ that are worn on a user's person using various form factors, such as a wristband 14 (FIG. 2), ring, shoe clip, and/or incorporated into garment items such as socks, shirt sleeves, shoes, etc.

The smart kinesiology device 12 includes a microprocessor 16 in communication with a transceiver 18 capable of communicating with nearby devices according to a wireless communication technology/protocol now known or developed in the future, such as NFC (Near Field Communications), ZigBee, WiFi, Bluetooth, Ultra Wide Band, and Wireless USB. The microprocessor 16 of the smart kinesiology device 12 receives and sends data via the wireless communication transceiver 18. The smart kinesiology device 12 may communicate with a mobile device 19, such as a mobile phone or tablet computer, executing a smart kinesiology mobile app. The smart kinesiology device 12 may also be Internet-capable with the capability to communicate with resources in the cloud 20 (including, e.g., databases, computing resources, the world wide web, and cellular networks). The smart kinesiology device 12 may also communicate with one or more other smart kinesiology devices 12′ and 12″.

The smart kinesiology device 12 also includes one or more user interface devices such as button(s) 22 that the user can manipulate to provide input to the microprocessor 16. The microprocessor 16 of the smart kinesiology device 12 also may receive motion data from one or more motion sensor(s) 24, such as a three-axis accelerometer and a three-axis gyroscope, that have the capability to detect the magnitude and direction of acceleration, and orientation. The smart kinesiology device 12 also includes a vibration alert generator 26 coupled to the microprocessor 16. The vibration alert generator 26 may be implemented by a miniature vibration motor. The smart kinesiology device 12 may employ a battery as the power source that may be rechargeable.

In operation, one or more smart kinesiology devices 12 are worn on the user's limbs, such as wrist and feet, and are capable of sensing, identifying, and monitoring the user's athletic movements, such as pitching, throwing, batting, swinging, and kicking motions, as the user trains and plays a sport. The user, his/her coaches, and his/her parents/guardians may access, view, and obtain data and reports associated with the user's physical conditioning, training, and game play. For certain sports where limits are set by guidelines, such as MLB pitch smart guidelines that limits a 15-year old to 95 pitches per game, for example, the smart kinesiology device 12 can recognize and track the number of pitches, and issue alerts when the number has been exceeded. They may access, in real-time, physical conditioning and training data as the user is progressing through his/her routine, as well as during competition. Further, a smart kinesiology device 12 may communicate with one or more mobile devices (running the smart kinesiology mobile app) that are accessible to coaches, other athletes (on the same team, in the same class, in the same school), parents, trainers, and doctors depending on permissions set by the user.

The athlete can be led by the smart kinesiology mobile app to execute certain physical conditioning moves, practice pitches, kicks, etc. The athlete's movement data may be analyzed to identify ways that the user's movement can be improved to achieve better results like faster pitches, more accurate swings, etc. The analysis may also identify behaviors or motions that may potentially lead to injuries. The analysis and feedback may employ the use of summary graphs in presentation areas like numbers of athletic motions (pitches, throws, kicks, etc.), quota achievement percentages, number of alerts, daily work out summaries and easy to access cumulative history over any time period, date and description of an athletic injury.

Data transparency to athlete, overlapping season coaches, strength trainers, medical-training staff, and parents are made possible via accessing their athlete's account on their cell phone or tablet. If a parent is in one city and their athlete is playing in another, the parent can view real-time data associated with the athlete's training and game play. Coaches can view a athlete's planned off-season activity on any day by viewing their mobile device even though they are in different cities and separated by many miles. A team doctor who assigns a rehab regimen to a athlete recovering from injury can also remotely access data and determine whether the athlete is compliant with the program.

FIG. 2 is an illustration of a wearable smart kinesiology device 12 according to the teachings of the present disclosure. The smart kinesiology device 12 may include one or more buttons 22 that enable a user to initiate a procedure, such as monitoring a pitching exercise drill, for example. The smart kinesiology device 12 may be attached or incorporated with a wristband so that the user may wear it around his/her pitching or throwing arm. The smart kinesiology device 12 may also be incorporated with other form factors to attach to parts of the user's body and/or limbs and/or articles of clothing. For example, the smart kinesiology device 12 may incorporate a clip that may be attached to the user's shoe(s). Although not shown, the smart kinesiology device 12 may include other forms of user interface devices, such as LED, display, audible alert, etc.

FIGS. 3-5 are exemplary data displays on the mobile devices 19 associated with the smart kinesiology device 12 according to the teachings of the present disclosure. A smart kinesiology mobile app is downloaded to the mobile device 19 from a play store or cloud server for execution on the mobile platform. With the smart kinesiology mobile app executing on the mobile device 19, the user may set up a profile, download various levels of drill packages designed and tailored for the user's sport and position, record the user's performance data, and obtain analysis of the athletic movement data. The user may also authorize other users access to his/her data. An authorized user such as a coach may also instruct, using his/her own mobile device, to download specific drill packages to the athlete's mobile device.

FIG. 3 shows an exemplary display for a pitcher development drill package that includes a number of exemplary drills for conditioning and training a pitcher, and the number of recommended iterations of each drill to be performed by the user (displayed as “Quota” in FIG. 3). The recommendation is based on the user's age, level of physical conditioning and skills, his/her coach's preferences, and other factors. Using the smart kinesiology device 12, the user's athletic motions are automatically tracked and monitored by the motion sensors 24 and provided to the microprocessor 16 so that each time the drill is practiced, the movements are sensed, recognized, and recorded. The display of the mobile device is also automatically updated to reflect the user's progress through the drills in the drill package. This is shown in the “Actual” column on the display. When the user reaches the number of iterations set in the quota, the vibration alert generator 26 is activated by the microprocessor 16 to alert the user that the current drill has been completed and to move on to the next drill.

The microprocessor is also able to determine that the user has performed any movement or drill beyond the recommended quota called for in the drill package, and issue appropriate alerts according to the user's settings. For example, the user performed 36 pre-game warm up pitches instead of the recommended 25, so the smart kinesiology device 12 issued two vibration alerts, once when the quota was reached and a second time when ten pitches over the recommended number was performed. This data is also noted on the display. Because the smart kinesiology mobile app can be used to monitor and keep track of the user's movements during practice training as well as during competition, it can determine the next available date that the user can safely pitch another game according to MLB pitching guidelines to avoid fatigue and injury. It also allows the user to report any injury sustained so that the workout and game participation can be tailored to accommodate the injury.

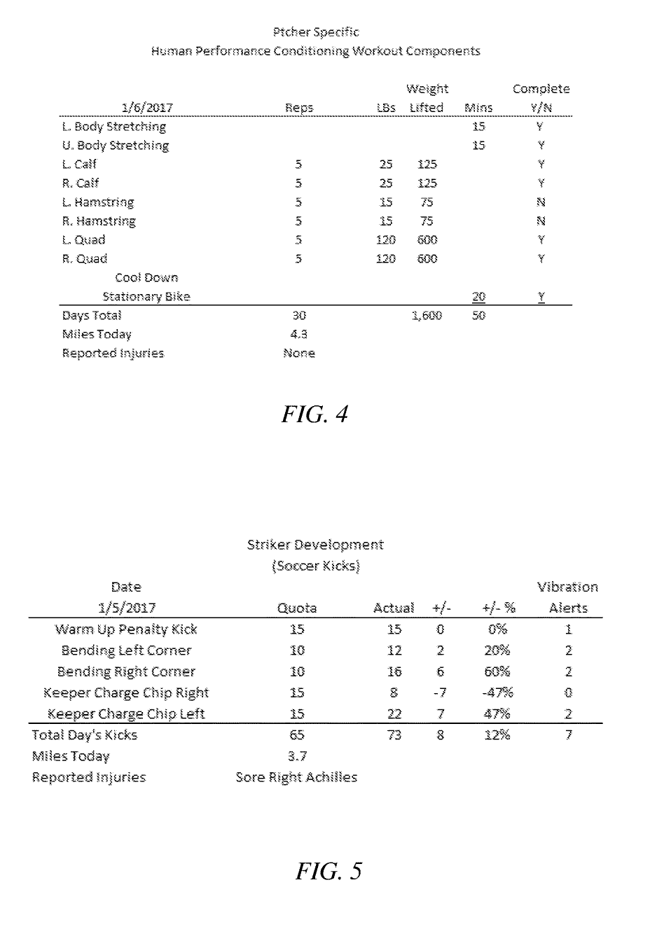

FIG. 4 shows an exemplary data display for a position-specific conditioning workout drill package for a baseball pitcher that includes a number of recommended conditioning and strengthening drills, including stretching movements and weight lifting. Again, using the smart kinesiology device 12, at least some of the drills can be automatically tracked and monitored by the motion sensors 24 and provided to the microprocessor 16 so that the number of times each conditioning drill is performed is detected, recognized, and recorded. The user may press or activate the button 22 of the smart kinesiology device 12 at the completion of some drills to progress to the next movement. The display of the is also automatically updated to reflect the user's progress through the list of drills in the drill package.

As a further example, FIG. 5 shows an exemplary data display for a position-specific conditioning workout drill package for a soccer striker that includes a number of recommended warm-up kicks, and other kicking motions. Using the smart kinesiology device 12, the movement of the user doing each drill can be automatically sensed and monitored by the motion sensors 24 and provided to the microprocessor 16 so that the number of times each conditioning drill is performed is detected, recognized, and recorded. The display of the mobile device is also automatically updated to reflect the user's progress through the list of drills in the drill package. When the user reaches the number of iterations set in the quota, the vibration alert generator 26 is activated by the microprocessor 16 to signify the completion of that drill and to alert the user to move on to the next drill in the drill package.

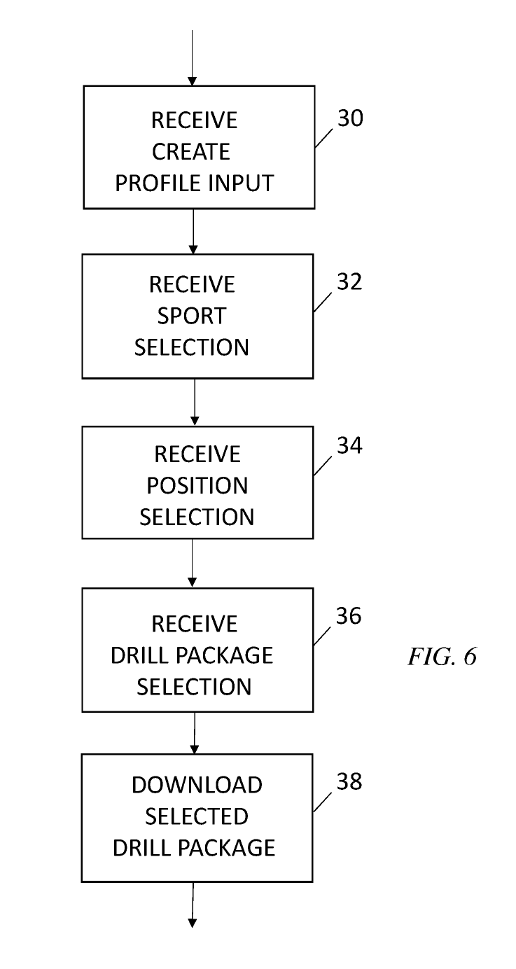

FIG. 6 is a flowchart of an exemplary embodiment of the process associated with profile creation according to the teachings of the present disclosure. In blocks 30-34, the user inputs data for his/her profile, such as name, age, gender, weight, height, type of sport, position played, etc. The user and/or his/her coach also select and download one or more drill packages that are tailored to his/her age, gender, level of physical conditioning, type of sport, position played, and other factors. These drill packages include drills designed to strengthen the athlete's physical conditioning and improve the athlete's skills.

The athlete may first configure a new drill package by proceeding through each drill in the package and train the motion sensors and smart kinesiology mobile app to recognize the movement associated with each drill. For example, if the drill package includes fast pitching, the athlete may throw a fast pitch three times to configure the motion sensors and smart kinesiology mobile app. Alternatively, the smart kinesiology mobile app may have access to a library of motion data that enable it to automatically recognize certain athletic movements without initiation or configuration.

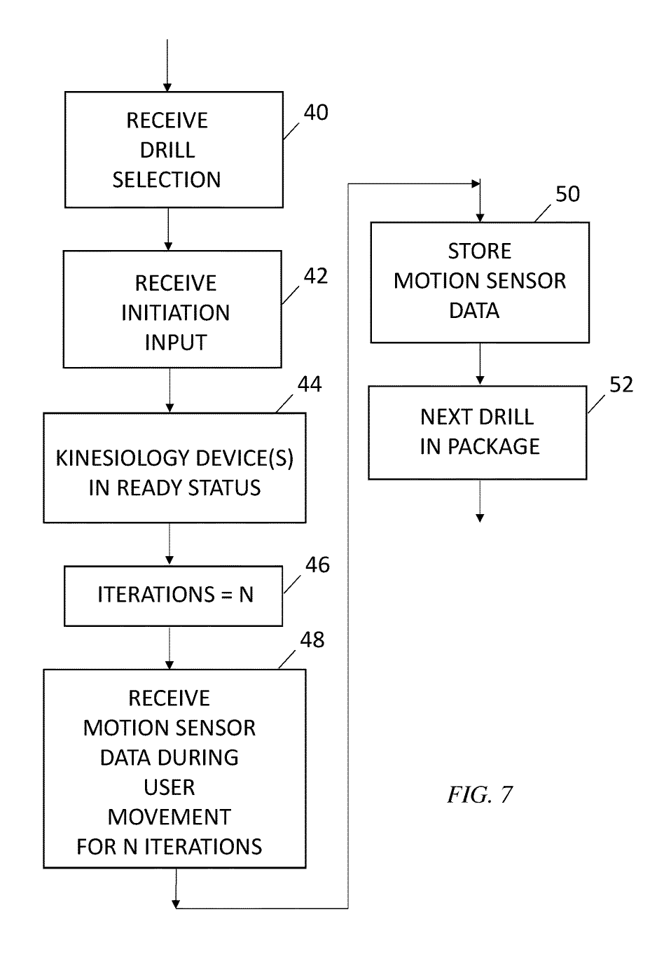

FIG. 7 is a flowchart of an exemplary embodiment of the physical conditioning and training process associated with the smart kinesiology device and mobile app according to the teachings of the present disclosure. In block 40, the smart kinesiology device or the mobile app receive a user input to select a specific drill package. In block 42, the process is initiated by receiving the appropriate user input, such as pushing the button 22 on the smart kinesiology device, or clicking a particular spot on the screen of the mobile device. In response to receiving the user's initiation input, the smart kinesiology device is in the ready status to automatically sense and track the user's movement for the first drill in the drill package, as shown in block 44. The number of iterations is set in block 46. The motion sensors then generate movement data and transmit the data to the mobile device, as shown in block 48. The number of times the user performs the drill is detected, monitored, and recorded, as shown in block 50. Vibration alerts are issued by the microprocessor when the athlete reaches the quota set for each drill and when the athlete exceeds the quota by certain number of iterations. The user may complete the drill and move on to the next drill in the package, as shown in block 52. The display of the mobile device is updated as the user progresses through the number of iterations of the drill, and further through all of the drills in the drill package. The mobile device further uploads the data to the cloud so that users that have been authorized to have access to the user's data can view the data in real time using their own mobile devices or computing devices. The motion sensors in the smart kinesiology device and mobile app are capable of detecting the user's athletic motions while performing each drill, and recognize how many times the user performs the drill.

A user may also consent to anonymously share data for the purpose of broad population studies. The mobile app may determine and present smart links to helpful resources and information based on analysis of the user's motions, preferences, likes and dislikes, etc. The smart kinesiology device and mobile app may also include a coaching function that provides a coach or trainer a “how to” guide to get the most from the system with his team members.

The smart kinesiology mobile app software may include access to a comprehensive digital library of kinesiology-crafted human performance regimens to prepare any team or general fitness athlete for the sport they play. For team sport players, each position for every team sport has a sports science “how to” prepare for the rigors of playing that position. An offensive lineman in football has the ideal human performance conditioning regimen to prepare him for the rigors of playing that position, and the same for a forward in basketball, a quarterback in football, a right fielder in baseball, a striker in soccer, and so on. These position-specific workouts are accessible anytime to a user and his/her coaches. For general athletes, a long-distance runner should have a different workout than a wrestler or a hurdler or a gymnast. For any athlete, if they engage in most known sporting activities, the software would guide them through the steps to build their bodies to prepare for the specific demands of their sport. The smart kinesiology device and mobile app also tracks the number of steps taken by the user and convert to a unit of distance (e.g., miles or kilometers), so the athlete will always know the distance traveled during any activity: at school, on a vacation, during a workout, game or walking from class to class during school. As is the case with motion tracked data, the physical conditioning data will be visible and transparent to the athlete, coaches, parents and anyone the athlete authorizes access.

The present disclosure describes a smart kinesiology platform of training products whose aim is to improve performance and minimize injury for athletes that throw, swing, shoot, and or kick objects while training. The backbone of the platform is an integrated technology comprised of a revolutionary wearable smart kinesiology device and a mobile app (executing on a mobile computing device such as a mobile phone) that constantly communicate with each other. When training, the system monitors the specifics of a workout, the progress during that work out, and communicates to the mobile device (and database in the cloud to enable access by others) any milestones, progress, and potentially injurious behaviors. This smart kinesiology platform is designed to guide athletes in a wide variety of sports, for example, baseball (throwing and batting), softball (throwing and batting), basketball (shooting), football (throwing and G-Force), soccer (kicking), lacrosse (swinging), racquetball (swinging), handball (swinging), cricket (swinging), bowling (throwing), track and field (throwing), golf (swinging), hockey (swinging and G-Force), and tennis (swinging) through suggested, basic, advanced, high performance, professional level, and personalized training/coaching sessions.

Examples of athlete feedback may include: when a baseball warm up session that was planned for 20 throws should end, if a pitcher does not change ball velocity after three throws, if the smart kinesiology device senses a curve ball when the pitcher intended to throw a fastball, and if the smart kinesiology device senses that a pitch exceeds 60 mph. The athlete can choose alerts in the form of vibration, light, sound, pre-recorded messages from the athlete, or a menu of voice responses as the form of communication it receives from the smart kinesiology device.

The features of the present invention which are believed to be novel are set forth below with particularity in the appended claims. However, modifications, variations, and changes to the exemplary embodiments described above will be apparent to those skilled in the art, and the system and method of sports motion monitoring, analysis, and coaching described herein thus encompasses such modifications, variations, and changes and are not limited to the specific embodiments described herein.

What is claimed is:

1. A smart kinesiology system, comprising:
a mobile app executing on a mobile device displaying a plurality of drills; and
a smart kinesiology device configured to be worn by an athlete, comprising:
a microprocessor;
a transceiver coupled to the microprocessor and configured for wireless communication with the mobile app;
a user interface device in communication with the microprocessor for receiving user input;
a motion sensor module coupled to the microprocessor and configured for sensing and measuring motions of the athlete performing the plurality of drills, generating motion data, and providing the motion data to the microprocessor;
a vibrator coupled to the microprocessor configured for generating a vibration in response to receiving an instruction from the microprocessor; and
the microprocessor being configured to receive the measured athlete motion data from the motion sensor module, transmit the motion data to the mobile device, display the athlete's progress through the plurality of drills, and provide feedback information to the athlete via the vibrator based on the athlete's progress through the plurality of drills.

2. The system of claim 1, wherein the motion sensor module is configured to sense and measure magnitude, direction, and orientation associated with the athlete's movement.

3. The system of claim 1, wherein the motion sensor module is configured to sense and measure distance traveled associated with the athlete's movement.

4. The system of claim 1, wherein the motion sensor module comprises a three-axis accelerometer.

5. The system of claim 1, wherein the motion sensor module comprises a three-axis gyroscope.

6. The system of claim 1, wherein the mobile app is configured to recognize one of the plurality of drills from the athlete's motion data received from the smart kinesiology device.

7. The system of claim 1, wherein the mobile app is configured to recognize an athletic movement selected from the group consisting of a pitch (baseball and softball), a throw (football, baseball, and softball), a kick, a swing (of a baseball/softball bat, tennis racquet, golf club, hockey stick, and cricket bat).

8. The system of claim 1, wherein the smart kinesiology device is worn around the athlete's wrist.

9. The system of claim 1, wherein the smart kinesiology device is attached to the athlete's shoe.

10. The system of claim 1, wherein the smart kinesiology device is incorporated into the athlete's garment.

11. A smart kinesiology method, comprising:
displaying a plurality of athletic drills on a display of a mobile device, including a recommended count and an actual count for each drill;
sensing and measuring motions of an athlete performing each of the plurality of drills, generating motion data, and providing the motion data to a microprocessor;
automatically and wirelessly transmitting the motion data to the mobile device;
analyzing the motion data and recognizing the motion data as being associated with at least one of the plurality of drills;
incrementing the actual count of the recognized drill displayed by the mobile device;
comparing the actual count with the recommended count for the recognized drill; and
providing a vibrating output to alert the athlete in response to the actual count being equal to the recommended count.

12. The method of claim 11, wherein sensing and measuring motions of the athlete comprises sensing and measuring magnitude, direction, and orientation associated with the athlete's movement.

13. The method of claim 11, wherein sensing and measuring motions of the athlete comprises sensing and measuring distance traveled associated with the athlete's movement.

14. The method of claim 11, recognizing the motion data as being associated with at least one of the plurality of drills comprises recognizing an athletic movement selected from the group consisting of a pitch (baseball and softball), a throw (football, baseball, and softball), a kick, a swing (of a baseball/softball bat, tennis racquet, golf club, hockey stick, and cricket bat).

15. The method of claim 11, further comprising giving authorization to at least one of a coach and a parent to access the motion data.

16. The method of claim 11, further comprising downloading an athletic drill package onto a mobile device executing a mobile app for improving the skills of the athlete.

17. The method of claim 11, further comprising downloading a physical conditioning drill package onto a mobile device executing a mobile app for improving the physical conditioning of the athlete.

18. The method of claim 11, further comprising:
analyzing the motion data; and
identifying and recommending additional drills for improving the skills of the athlete.

19. The method of claim 11, further comprising:
receiving an indication of a sport type;
receiving an indication of a position for the sport type;
displaying a plurality of drill packages designed for the sport type and position;
receiving a selection of a drill package from the plurality of drill packages; and
downloading the selected drill package to the mobile device.

20. A smart kinesiology method, comprising:
receiving an indication of a sport type;
receiving an indication of a position for the sport type;
displaying a plurality of drill packages designed for the sport type and position;
receiving a selection of a drill package from the plurality of drill packages;
downloading the selected drill package to the mobile device;
displaying a plurality of drills of the downloaded drill package on a display of the mobile device, including a recommended count and an actual count for each drill;
sensing and measuring motions of an athlete performing each of the plurality of drills, generating motion data, and providing the motion data to a microprocessor;
automatically and wirelessly transmitting the motion data to the mobile device;
analyzing the motion data and recognizing the motion data as being associated with at least one of the plurality of drills;
incrementing the actual count of the recognized drill displayed by the mobile device;
comparing the actual count with the recommended count for the recognized drill; and
providing a vibrating output to alert the athlete in response to the actual count being equal to the recommended count.
